(19) United States
(12) Patent Application Publication
(10) Pub. No.: US 2008/0148136 A1
(43) Pub. Date: Jun. 19, 2008

(54) APPARATUS AND METHOD FOR TRANSMITTING/RECEIVING DATA IN A MOBILE COMMUNICATION SYSTEM

(75) Inventors: Byoung-Jae BAE, Suwon-si (KR); Soeng-Hun Kim, Suwon-si (KR); Do-Young Lee, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD, Suwon-si (KR)

(21) Appl. No.: 11/955,901

(22) Filed: Dec. 13, 2007

(30) Foreign Application Priority Data
Dec. 13, 2006 (KR) 127114-2006

(51) Int. Cl. H04L 1/00; G06F 11/00

(52) U.S. Cl. 714/799; 714/E11.002

(57) ABSTRACT

A method and apparatus for transmitting/receiving data between a RLC RESET sender and a RLC RESET receiver in a mobile communication system. In the RLC RESET operation of the mobile communication system, the present invention provides information on the normally received packet of each RLC entity's receiving side to the counterpart RLC entity's transmitting side to enable lossless data transmission for its succeeding packets, thereby preventing a loss of the transmission data, which may occur during the RLC RESET operation, and thus contributing to an increase in the transmission efficiency.

### PRIORITY

This application claims priority under 35 U.S.C. §119(a) to a Korean Patent Application filed in the Korean Intellectual Property Office on Dec. 13, 2006 and assigned Serial No. 2006-127114, the disclosure of which is incorporated herein by reference.

### BACKGROUND OF THE INVENTION

1. Field of the Invention

The present invention relates generally to a mobile communication system, and in particular, to a data transmission/reception apparatus and method for transmitting data without loss upon occurrence of a Radio Link Control (RLC) RESET in a mobile communication system.

2. Description of the Related Art

The Universal Mobile Telecommunication Service (UMTS) system is a 3^{rd} generation asynchronous mobile communication system that employs Wideband-Code Division Multiple Access (W-CDMA) based on Global System for Mobile Communications (GSM) and General Packet Radio Services (GPRS), both of which are European mobile communication systems.

In the 3^{rd} Generation Partnership Project (3GPP), which is in charge of UMTS standardization, discussion is being held on the Long Term Evolution (LTE) system as the next generation mobile communication system of the UMTS system. The LTE system is a technology for realizing high-speed packet-based communication at a data rate of a maximum of 100 Mbps, which is aimed for commercialization around year 2010. For the LTE system, several communication schemes are under discussion. For example, one scheme is for reducing the number of nodes located in the communication path by simplifying a configuration of the network, and another scheme is for maximally approximating radio protocols to a radio channel.

FIG. 1 illustrates an exemplary configuration of a general Evolved UMTS mobile communication system.

Referring to FIG. 1, an Evolved Radio Access Network (E-RAN) 110 is simplified to a 2-node configuration of Evolved Node Bs (ENBs, or Node Bs) 120, 122, 124, 126 and 128, and anchor nodes 130 and 132. A User Equipment (UE) 101 can access an Internet Protocol (IP) network by means of the E-RAN 110, for communication.

The ENBs 120 to 128, corresponding to the existing Node Bs of the UMTS system, are connected to the UE 101 over the radio channel. The ENBs 120 to 128, compared to the existing Node Bs, will perform complex functions. This is because in the LTE system, all user traffic including the real-time IP services such as the Voice over IP (VoIP) will be serviced over a shared channel. Therefore, there is a need for an apparatus for collecting status information of UEs and performing scheduling depending thereon. This collecting and scheduling is managed by the ENBs 120 to 128.

In the LTE system, like in the High Speed Downlink Packet Access (HSDPA) and Enhanced uplink Dedicated Channel (E-DCH) systems, Hybrid Automatic Repeat reQuest (HARQ) is performed between the ENBs 120 to 128 and the UE 101. However, because various Quality of Service (QoS) requirements cannot be satisfied only with the HARQ technique, outer ARQ can be performed in upper layers, and the outer ARQ is also performed between the UE 101 and the ENBs 120 to 128.

It is expected that the LTE system will use Orthogonal Frequency Division Multiplexing (OFDM) as a radio access technology in the 20-MHz bandwidth, in order to realize the data rate of a maximum of 100 Mbps. In addition, the LTE system will employ an Adaptive Modulation & Coding (AMC) scheme that adaptively determines a modulation scheme and a channel coding rate according to the channel status of the UE.

Many next generation mobile communication systems, including the LTE system, use both Hybrid Automatic Repeat reQuest (HARQ) and Automatic Repeat reQuest (ARQ), as error correction techniques.

The term ‘HARQ’ as used herein refers to a technique for soft-combining previously received data with its retransmitted data without discarding the previously received data, thereby increasing a reception success rate. More specifically, a HARQ receiving side determines the presence/absence of an error in a received packet, and transmits an HARQ positive Acknowledgement (HARQ ACK) signal or a HARQ negative Acknowledgement (HARQ NACK) signal to a HARQ transmitting side according to the error determination result. In response, the HARQ transmitting side performs retransmission of the HARQ packet or transmission of a new HARQ packet according to the HARQ ACK/NACK signal. Then the HARQ receiving side soft-combines the retransmitted packet with its previously received packet, thereby reducing an error occurrence rate.

However, the term ‘ARQ’ as used herein refers to a technique for checking sequence numbers of received packets and issuing a retransmission request for a missing packet (or a packet with a missing sequence number), and this technique does not soft-combine the previously received packet with the retransmitted packets.

In the LTE system, an RLC layer manages the ARQ operation and the HARQ operation is managed by a Media Access Control (MAC) or PHYsical (PHY) layer.

FIG. 2 illustrates a protocol structure of the general LTE system.

In the LTE system, one set of Packet Data Convergence Protocols (PDCPs) 205, 210, 215, 280, 285, and 290, and RLCs 220, 225, 230, 265, 270, and 275 is configured per service.

The PDCPs 205, 210, 215, 280, 285, and 290 control IP header compression/decompression, and the RLCs 220, 225, 230, 265, 270 and 275 reconfigure PDCP Packet Data Units (PDUs) into an appropriate size, and perform an ARQ operation thereon. As to the term ‘PDCP PDU’, a packet output from a particular protocol entity will be referred to herein as a ‘PDU’ of the protocol.

MAC layers 235 and 260, connected to several RLC entities configured in one UE, perform an operation of multiplexing RLC PDUs to a MAC PDU, and demultiplexing a MAC PDU into RLC PDUs.

HARQ layers 240 and 255 transmit/receive the MAC PDU by means of a predetermined HARQ operation, and PHYsical (PHY) layers 245 and 250 perform an operation of channel-coding and modulating upper layer data into an OFDM symbol and transmitting the OFDM symbol over a radio channel; or demodulating and channel-decoding an OFDM symbol received over a radio channel and delivering the OFDM symbol to the upper layer.

Generally, Layer 2 includes all of PDCP, RLC, and MAC layers. The term ‘RLC RESET control message’ as used herein refers to a control message of the RLC layer.

The PDCP, RLC, MAC entities, as shown in FIG. 2, each include a transmitting side and a receiving side in pairs. For example, the RLC transmitting sides 220, 225, and 230 are matched to the RLC receiving sides 265, 270, and 275, respectively, on a one-to-one basis.

FIG. 3 illustrates a method of transmitting/receiving RLC RESET control signals of the general Layer 2.

Like the general Layer-2 control message, the RLC RESET control message is composed of a control request message RLC RESET and a control response message RLC RESET ACK.

For the ARQ operation, control information, a parameter, and a timer are needed, and when necessary, the control information, the parameter, and the timer can be reset to their initial values. If Layer-2 315, requiring the RLC RESET operation, transmits an RLC RESET message to the counterpart Layer-2 310 in step 320, the Layer-2 310 resets the control information, the parameter, and the timer to their initial values, and transmits an RLC RESET ACK message to the counterpart Layer-2 315 in step 325. Because the transmission operation of the RLC RESET control message is performed by both the RLC layer and the MAC layer, the apparatus where the RLC RESET message undergoes generation, transmission, processing, and retransmission, is denoted by ‘RLC/MAC’.

During the RLC RESET operation, the side requiring the RLC RESET operation and its counterpart side discard all of the transmitted RLC PDUs and Service Data Units (SDUs), and after the RLC RESET operation, transmit the RLC PDUs and SDUs, a transmission attempt for which has not been made yet. Regarding the SDU, a packet input to a particular protocol entity will be referred to herein as a ‘SDU’ of the protocol.

However, because it is not possible to recognize whether the PDU, a transmission attempt for which was made in the RLC RESET operation, has been normally transmitted to the receiving side. If the PDU is not received at the receiving side the PDU suffers transmission failure, causing data loss, and the data loss causes a reduction in the data transmission rate.

The RLC RESET is performed, when the transmission of a particular packet has continuously failed for unknown reasons, or when an inconsistency is discovered in the RLC PDU sequence number. In this case, because the existing UMTS system applies a single procedure, the method of using a sequence number of the last successfully received RLC PDU to prevent the packet loss cannot be used in the RESET caused by the inconsistency of the RLC PDU sequence number. In the UMTS system, the PDCP PDU sequence number is not the information attached to every packet, but the information corresponding to the number of packets that the PDCP layer has successfully transmitted. Therefore, there is no way in which the RLC layer can determine the PDCP PDU sequence number (or RLC SDU sequence number).

That is, the UMTS system, as it exchanges sequence numbers of the successfully transmitted RLC PDUs, cannot commonly apply the method of preventing the packet loss occurring in the RESET process to all RESET scenarios, so the system has not considered a method for utilization of the method of preventing the packet loss occurring in the RESET process.

In addition, in the UMTS system, the RLC cannot acquire a sequence number of an RLC SDU (or PDCP PDU), so there is no possible method for preventing the packet loss in the RESET process by using the PDCP PDU sequence number.

### SUMMARY OF THE INVENTION

An aspect of the present invention is to address at least the problems and/or disadvantages and to provide at least the advantages described below. Accordingly, an aspect of the present invention is to provide a data transmission/reception apparatus and method for guaranteeing data continuity through lossless data transmission during packet transmission when RLC RESET occurs in a UE or ENB in a mobile communication system.

Another aspect of the present invention is to provide a data transmission/reception apparatus and method for increasing data transmission efficiency in a mobile communication system.

According to one aspect of the present invention, there is provided a method for transmitting/receiving data by a RLC RESET sender in a mobile communication system. The method includes, upon an occurrence of an Radio Link Control (RLC) RESET, generating an RLC RESET message and transmitting the RLC RESET message to a RLC RESET receiver; and upon receiving an RLC RESET ACKnowledgement (ACK) message from the RLC RESET receiver, reassembling an RLC Service Data Unit (SDU) using Packet Data Units (PDUs) in an RLC PDU buffer depending on a sequence number included in the RLC RESET ACK message, and transmitting the reassembled RLC SDU to an RLC SDU buffer. The sequence number includes a last sequence number of a PDU continuously sequentially received in an RLC PDU buffer of the RLC RESET receiver.

According to another aspect of the present invention, there is provided a method for transmitting/receiving data by a RLC RESET receiver in a mobile communication system. The method includes, upon receiving an Radio Link Control (RLC) RESET message from a RLC RESET sender, extracting a last sequence number of a Packet Data Unit (PDU) continuously sequentially received in a receiving-side RLC PDU buffer of the RLC RESET receiver; and generating an RLC RESET Acknowledgement (ACK) message including the extracted sequence number, and transmitting the RLC RESET ACK message to the RLC RESET sender.

According to further another aspect of the present invention, there is provided a method for transmitting/receiving data between a RLC RESET sender and a RLC RESET receiver in a mobile communication system. The method includes, upon an occurrence of an Radio Link Control (RLC) RESET, generating by the RLC RESET sender, an RLC RESET message and transmitting the RLC RESET message to the RLC RESET receiver; upon receiving the RLC RESET message from the RLC RESET sender, extracting by the RLC RESET receiver a last sequence number of a Packet Data Unit (PDU) continuously sequentially received in a receiving-side RLC PDU buffer of the RLC RESET receiver; generating by the RLC RESET receiver an RLC RESET ACKnowledgement (ACK) message including the extracted sequence number, and transmitting the RLC RESET ACK message to the RLC RESET sender; and upon receiving the RLC RESET ACK message from the RLC RESET receiver, reassembling, by the RLC RESET sender, an RLC Service Data Unit (SDU) using PDUs in an RLC PDU buffer depending on a sequence number included in the RLC RESET ACK message, and transmitting the reassembled RLC SDU to an RLC SDU buffer.

According to yet another aspect of the present invention, there is provided an apparatus for transmitting/receiving data in a RLC RESET sender of a mobile communication system. The apparatus includes a first message generator for generating an Radio Link Control (RLC) RESET message upon an occurrence of an RLC RESET; a transmitter for transmitting the generated RLC RESET message to a RLC RESET receiver; a receiver for transmitting, to a controller, an RLC RESET ACKnowledgement (ACK) message received from the RLC RESET receiver; an RLC Packet Data Unit (PDU) reassembler for reassembling an RLC Service Data Unit (SDU) using PDUs in an RLC PDU buffer of the RLC RESET receiver depending on a sequence number included in the RLC RESET ACK message; and the controller for performing a control operation of transmitting the reassembled SDU to the RLC SDU buffer. The sequence number includes a last sequence number of a PDU continuously sequentially received in an RLC PDU buffer of the RLC RESET receiver.

According to still another aspect of the present invention, there is provided an apparatus for transmitting/receiving data in a RLC RESET receiver of a mobile communication system. The apparatus includes a receiver for receiving an Radio Link Control (RLC) RESET message from a RLC RESET sender; a sequence number extractor for extracting a last sequence number of a Packet Data Unit (PDU) continuously sequentially received in a receiving-side RLC PDU buffer of the RLC RESET receiver; a second message generator for generating an RLC RESET ACKnowledgement (ACK) message including the extracted sequence number; and a transmitter for transmitting the generated RLC RESET ACK message to the RLC RESET sender.

### BRIEF DESCRIPTION OF THE DRAWINGS

The above and other aspects, features and advantages of the present invention will become more apparent from the following detailed description when taken in conjunction with the accompanying drawings in which:

FIG. 1 illustrates an exemplary configuration of a general Evolved UMTS mobile communication system;

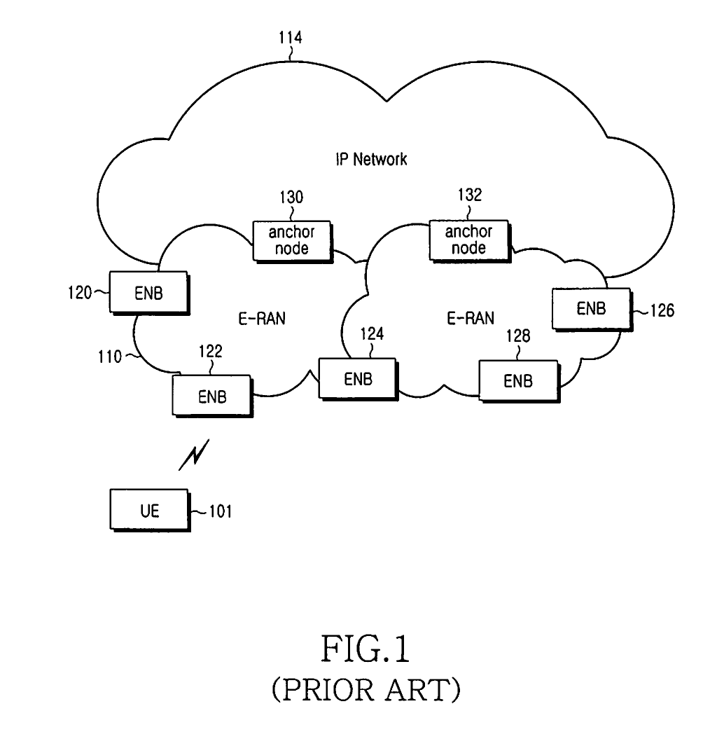

FIG. 2 illustrates a protocol structure of the general LTE system;

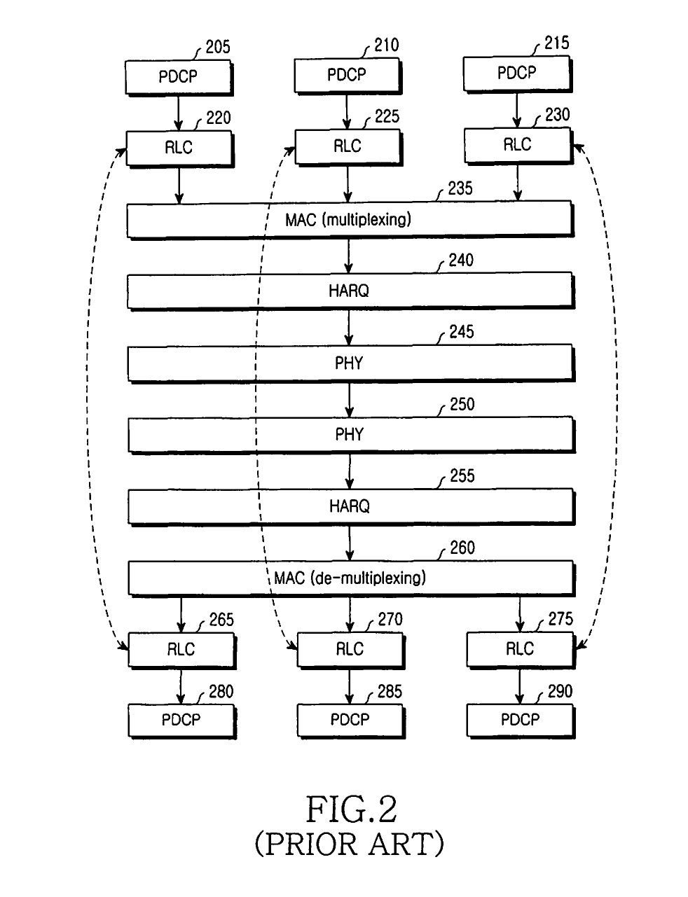

FIG. 3 illustrates a method of transmitting/receiving RLC RESET control signals of a general Layer 2;

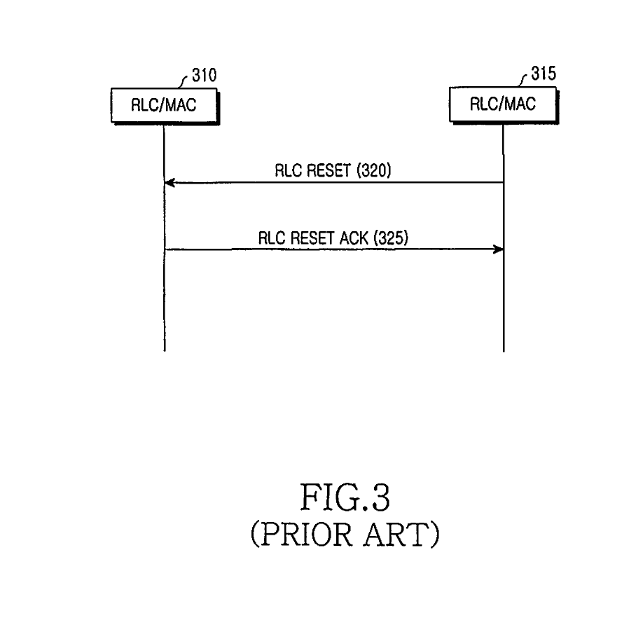

FIG. 4 illustrates a data transmission/reception method in a mobile communication system according to a first embodiment of the present invention;

FIG. 5 illustrates a data transmission/reception method by a RLC RESET sender in a mobile communication system according to the first embodiment of the present invention;

FIG. 6 illustrates a data transmission/reception method performed by a RLC RESET receiver in a mobile communication system according to the first embodiment of the present invention;

FIG. 7 illustrates a data transmission/reception method performed by a RLC RESET sender and a RLC RESET receiver in a mobile communication system according to the first embodiment of the present invention;

FIG. 8 illustrates a data transmission/reception method in a mobile communication system according to a second embodiment of the present invention;

FIG. 9 illustrates a data transmission/reception method in a mobile communication system according to a third embodiment of the present invention; and

FIG. 10 illustrates a structure of a data transmission/reception apparatus in a mobile communication system according to an embodiment of the present invention.

### DETAILED DESCRIPTION OF THE PREFERRED EMBODIMENTS

Preferred embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for clarity and conciseness.

The present invention provides an apparatus and method in which, during transmission of an RLC RESET message and an RLC RESET ACK message, data receiving-side buffers check a sequence number of the sequentially normally received RLC PDU (or SDU), add the sequence number to the RLC RESET message and the RLC RESET ACK message, and transmit the messages to their associated data transmitting sides, and transmitting sides of a UE and an ENB use them, thereby transmitting data without loss.

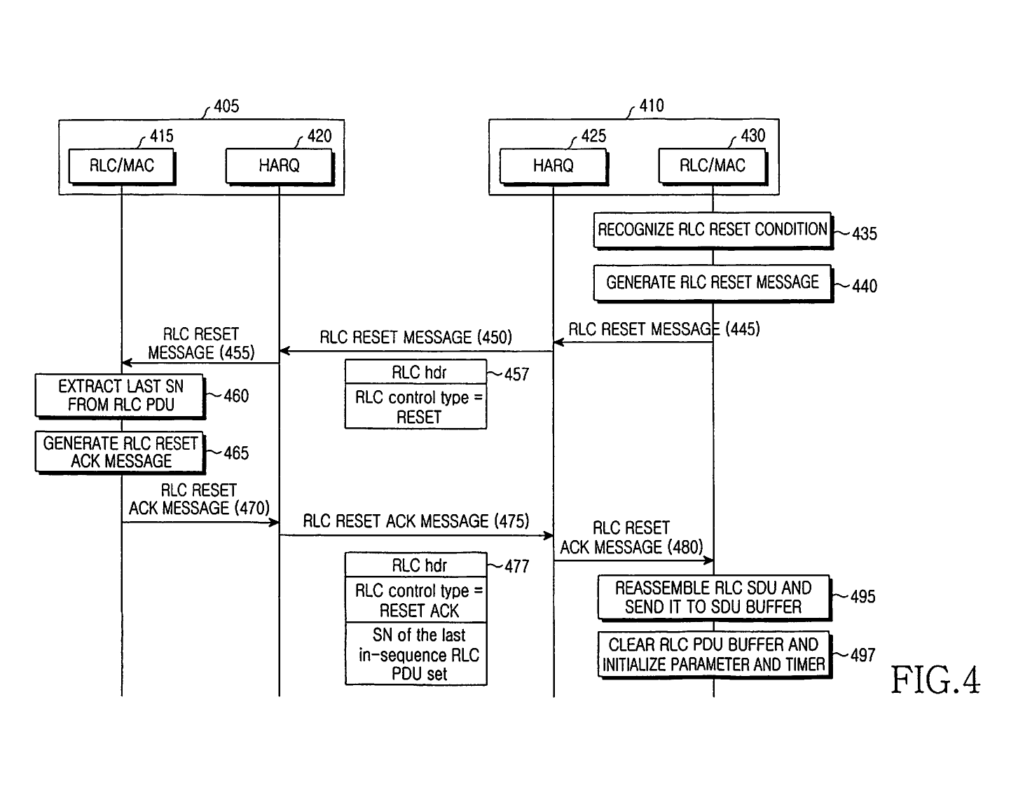

FIG. 4 illustrates a data transmission/reception method in a mobile communication system according to a first embodiment of the present invention. With reference to FIG. 4, a description will be made of a method in which a RLC RESET sender prevents packet loss in an RLC RESET process by using a sequence number of an RLC PDU successfully transmitted from a RLC RESET receiver through an RLC RESET ACK message. Similarly, the RLC RESET receiver also prevents the packet loss by receiving a sequence number of the RLC PDU successfully transmitted through an RLC RESET message.

Because both the RLC layer and the MAC layer perform the transmission operation of the RLC RESET control message, the apparatus where the RLC RESET message undergoes generation, transmission, processing, and retransmission, is denoted by ‘RLC/MAC’. In the following description, the terms ‘RLC RESET receiver 405’ and ‘RLC resetRLC RESET sender sender 410’ will be used.

In FIG. 4, the RLC RESET senderRLC RESET sender 410 is a node that generates and transmits an RLC RESET message, and the RLC RESET receiver 405 is a node that receives the RLC RESET message and transmits an RLC RESET ACK message in response thereto. As described above, RLC entities of the RLC layers exist in pairs, and each entity is composed of a transmitting side for transmitting an arbitrary packet in the entity itself, and a receiving side for receiving a packet.

In the following description, HARQ serves as both a transmitting device and a receiving device.

Upon recognizing an RLC RESET condition in step 435, an RLC/MAC layer 430 of the RLC RESET sender 410 generates an RLC RESET message and completes transmission preparation for the RLC RESET message in step 440. Herein, when the transmission of a particular packet is continuously failed for unknown reasons, or when inconsistency is discovered in the RLC PDU sequence number the RLC RESET is performed.

The RLC/MAC layer 430 of the RLC RESET sender 410 transmits the transmission-prepared RLC RESET message to the RLC RESET receiver 405 via HARQ 425 in steps 445 and 450. Herein, the RLC RESET message includes a status of a receiving-side buffer of the RLC RESET sender 410. The buffer status included in the RLC RESET message is shown by reference numeral 457. In the buffer status, RLC control type is indicated as ‘RESET’. When the counterpart HARQ 420 transmits an HARQ ACK in response to the HARQ packet transmitted by the HARQ 425, the HARQ packet transmission is completed.

After transmitting the RLC RESET message, the RLC RESET sender 410 stops the HARQ packet transmission by the corresponding RLC entity and resets the HARQ PDU.

Upon receiving the RLC RESET message in step 455, an RLC/MAC layer 415 of the RLC RESET receiver 405 stops the corresponding HARQ packet transmission and resets the HARQ PDU. Thereafter, the RLC/MAC layer 415 of the RLC RESET receiver 405 clears the RLC PDU buffer, and initializes the necessary control information, the parameter, and the timer.

After the RESET process, the RLC/MAC layer 415 of the RLC RESET receiver 405 extracts the last sequence number of the continuously sequentially received PDU from its receiving-side RLC PDU buffer, in step 460. Thereafter, the RLC RESET receiver 405 generates an RLC RESET ACK message including the extracted sequence number and completes transmission preparation for the generated RLC RESET ACK message, in step 465.

In steps 470 and 475, the RLC/MAC layer 415 of the RLC RESET receiver 405 transmits the transmission-prepared RLC RESET ACK message to the RLC RESET sender 410 via the HARQ 420. Herein, the RLC RESET ACK message includes a receiving-side buffer status of the RLC RESET receiver 405.

The receiving-side buffer status, in which RLC control type is indicated as ‘RESET ACK’, includes the last Sequence Number (SN) of the PDU sequentially received in the RLC PDU buffer of the RLC RESET receiver 405, as shown by reference numeral 477.

Upon receiving the RLC RESET ACK message in step 480, the RLC/MAC layer 430 of the RLC RESET sender 410 reassembles an RLC SDU using the PDUs in the RLC PDU buffer of the corresponding RLC entity's receiving side, depending on the sequence number included in the RLC RESET ACK message, and transmits the reassembled SDU to the RLC SDU buffer, in step 495.

Thereafter, in step 497, the RLC/MAC layer 430 of the RLC RESET sender 410 clears the RLC PDU buffer, and initializes the necessary control information, parameter and timer, completing the RLC RESET control process.

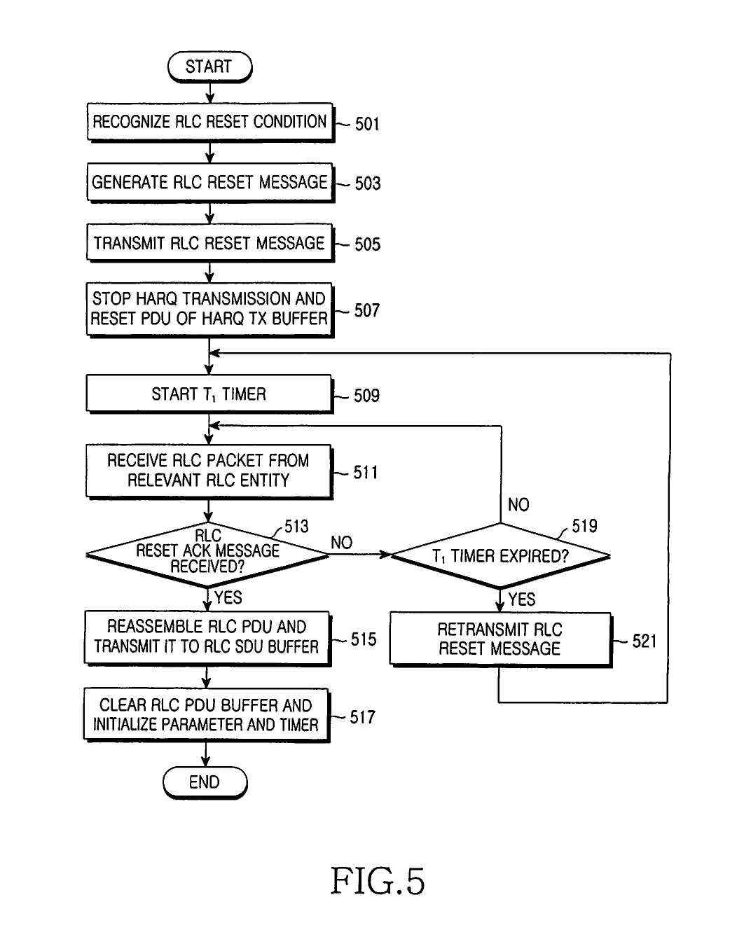

FIG. 5 illustrates a data transmission/reception method by a RLC RESET sender in a mobile communication system according to the first embodiment of the present invention.

For convenience, an RLC packet generated in a relevant RLC entity will be referred to herein as a ‘relevant RLC packet’. As described above, the RLC entities exist in pairs, and the RLC packet generated by an arbitrary RLC entity is transmitted to the counterpart RLC entity. In this way, the RLC entities that exchange RLC packets with each other are called the relevant RLC entities, and for an arbitrary RLC entity, the relevant RLC packet means an RLC packet generated in the counterpart RLC entity.

Upon recognizing an RLC RESET condition in step 501, an RLC/MAC layer 430 of a RLC RESET sender 410 generates an RLC RESET message in step 503, and transmits the generated RLC RESET message to a RLC RESET receiver 405 via a lower-layer HARQ 425 in step 505.

In step 507, the lower-layer HARQ 425 stops the ongoing HARQ transmission of the user data, and resets a PDU of a transmitting buffer.

In step 509, a controller of the RLC RESET sender 410, described below, starts a T₁ timer at the time the transmission of the HARQ packet with the RLC RESET message is completed.

Thereafter, in step 511, the RLC RESET sender 410 receives the RLC packet transmitted by the relevant RLC entity.

The RLC RESET sender 410 determines whether the RLC RESET sender has received an RLC RESET ACK in response to the RLC RESET message, in step 513. That is, the RLC RESET sender 410 determines whether RLC RESET ACK is included in the RLC packet transmitted by the relevant RLC entity. The T₁ is set as a value corresponding to a processing delay of the RLC control request message, and this value, for example, when an RLC entity is established, can be sent to the RLC entity by the upper layer. Upon failure to receive the RLC RESET ACK message for T₁ in step 513, the RLC RESET sender 410 proceeds to step 519.

However, if the RLC RESET receiver 405 has normally received the RLC RESET message transmitted by the RLC RESET sender 410, the RLC RESET ACK message should be included in the RLC packet.

If it is determined in step 513 that the RLC RESET ACK message is included in the RLC packet, the RLC RESET sender 410 proceeds to step 515, and otherwise, proceeds to step 519.

Upon receipt of the RLC RESET ACK message, in step 515, the RLC RESET sender 410 reassembles an RLC SDU using PDUs in the RLC PDU buffer depending on the sequence number in the RLC RESET ACK message, and transmits the reassembled RLC SDU to the RLC SDU buffer. In this case, the RLC RESET sender 410 reassembles only up to the PDU associated with the SDU corresponding to the sequence number transmitted from the RLC RESET receiver 405.

In step 517, the RLC RESET sender 410 clears the RLC PDU transmitting buffer, and initializes the necessary protocol parameter and timer.

Upon a failure to receive the RLC RESET ACK message in step 513, the RLC RESET sender 410 checks the T₁ timer in step 519 and determines whether the timer has expired.

If the T₁ timer has not expired, the RLC RESET sender 410 proceeds to step 511. However, if the T₁ timer has expired, the RLC RESET sender 410 retransmits the RLC RESET message to the RLC RESET receiver 405 in step 521. After the retransmission, the RLC RESET sender 410 returns to step 509 where the RLC RESET sender 410 starts the T₁ timer.

If the RLC RESET ACK message is received in the course of performing the retransmission step, the RLC RESET sender 410 immediately stops the retransmission process, and proceeds to steps 515 and 517, completing the data transmission process.

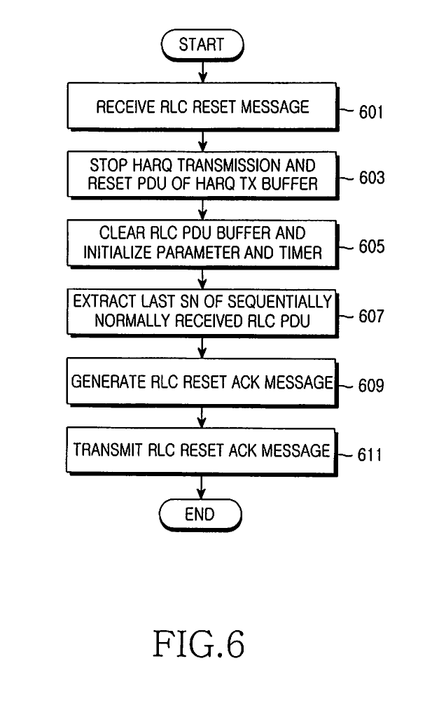

FIG. 6 illustrates a data transmission/reception method performed by a RLC RESET receiver in a mobile communication system according to the first embodiment of the present invention, i.e., FIG. 6 illustrates a data reception method performed by the RLC RESET receiver of FIG. 4.

If an RLC/MAC layer 415 of the RLC RESET receiver 405 receives an RLC RESET message in step 601. In step 603, a lower-layer HARQ 420 stops the ongoing HARQ transmission of the user data and resets PDU of a transmitting buffer.

In step 605, the RLC/MAC layer 415 of the RLC RESET receiver 405 clears an RLC PDU transmitting buffer, and initializes the necessary protocol parameter and timer.

In step 607, the RLC/MAC layer 415 of the RLC RESET receiver 405 extracts the last sequence number of the continuously sequentially received PDU from the RLC PDU buffer of its receiving side.

The RLC/MAC layer 415 of the RLC RESET receiver 405 generates an RLC RESET ACK message including the extracted sequence number of the RLC PDU in step 609, and transmits the generated RLC RESET ACK message to the RLC RESET sender 410 via the lower-layer HARQ 420 in step 611.

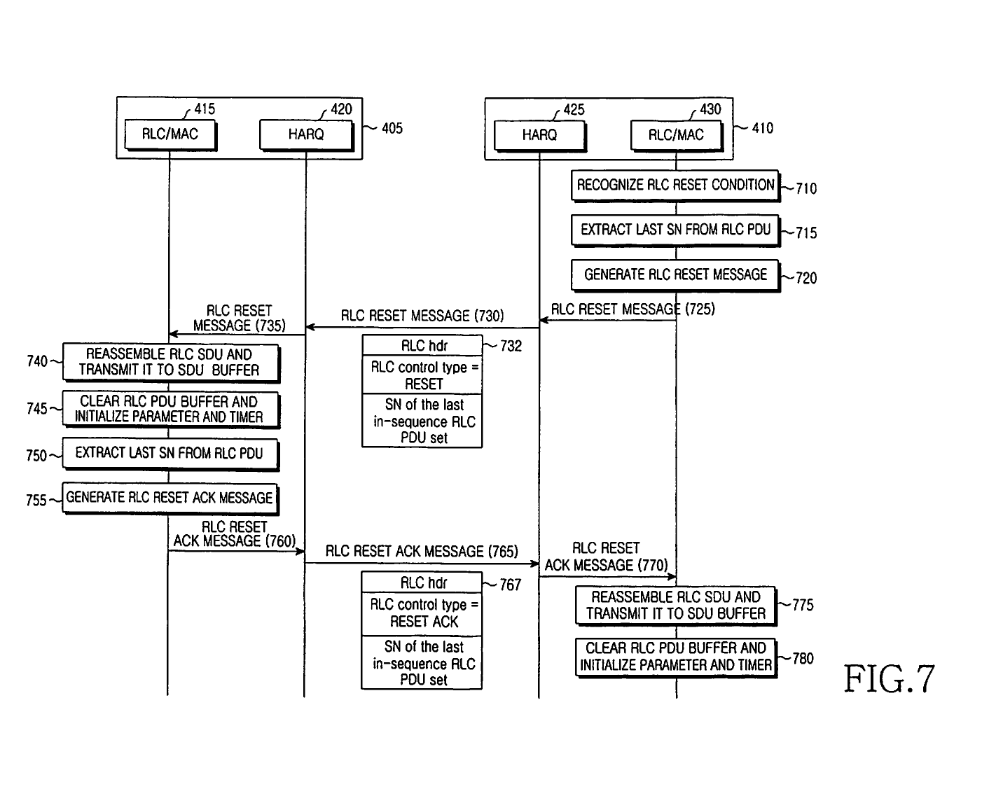

FIG. 7 illustrates a data transmission/reception method performed by a RLC RESET sender and a RLC RESET receiver in a mobile communication system according to the first embodiment of the present invention. The entire operation of the RLC RESET sender and the RLC RESET receiver for the RLC RESET process that uses the last sequence number of the successfully received RLC PDU are shown in FIG. 7.

Upon recognizing an RLC RESET condition in step 710, an RLC/MAC layer 430 of the RLC RESET sender 410 extracts the last sequence number of the continuously sequentially received PDU from the RLC PDU buffer of its receiving side, in step 715. Thereafter, in step 720, the RLC/MAC layer 430 of the RLC RESET sender 410 generates an RLC RESET message including the extracted sequence number, and completes transmission preparation for the RLC RESET message.

In steps 725 and 730, the RLC/MAC layer 430 of the RLC RESET sender 410 transmits the transmission-prepared RLC RESET message to a RLC RESET receiver 405 via HARQ 425. Herein, the RLC RESET message includes a receiving-side buffer status of the RLC RESET sender 410.

The buffer status included in the RLC RESET message is denoted by reference numeral 732. The buffer status, in which ‘RESET’ indicates the RLC control type, includes the last SN of the PDU sequentially received in the RLC PDU buffer of the RLC RESET sender 410. The HARQ packet transmission is completed when the counterpart HARQ 420 transmits a HARQ ACK in response to the HARQ packet transmitted by the HARQ 425.

After transmitting the RLC RESET message, the RLC RESET sender 410 stops the HARQ packet transmission by the corresponding RLC entity, and resets the HARQ PDU.

Upon receiving the RLC RESET message in step 735, the RLC/MAC layer 415 of the RLC RESET receiver 405 stops the corresponding HARQ packet transmission, and resets the HARQ PDU. In step 740, the RLC/MAC layer 415 of the RLC RESET receiver 405 reassembles an RLC SDU using the PDUs in the RLC PDU buffer of the corresponding RLC entity's receiving side depending on the sequence number included in the RLC RESET message, and transmits the reassembled RLC SDU to the RLC SDU buffer. In the foregoing operation of the present invention, the transmitting side of the RLC entity receives information on the normally received packet from the relevant RLC entity's receiving side, and transmits the packets from its succeeding packet depending on the received information, thus enabling lossless data transmission.

Thereafter, in step 745, the RLC/MAC layer 415 of the RLC RESET receiver 405 clears the RLC PDU buffer, and initializes the necessary control information, parameter and timer.

After the RESET process, in step 750, the RLC/MAC layer 415 of the RLC RESET receiver 405, like the RLC RESET sender 410, extracts the last sequence number of the continuously sequentially received PDU from the RLC PDU buffer of its receiving side. Thereafter, in step 755, the RLC/MAC layer 415 of the RLC RESET receiver 405 generates an RLC RESET ACK message including the extracted sequence number, and completes transmission preparation for the generated RLC RESET ACK message.

In steps 760 and 765, the RLC/MAC layer 415 of the RLC RESET receiver 405 transmits the transmission-prepared RLC RESET ACK message to the RLC RESET sender 410 via the HARQ 420. Herein, the RLC RESET ACK message includes a status of the receiving-side buffer of the RLC RESET receiver 405. The status of the receiving-side buffer, in which the RLC control type is indicated as ‘RESET ACK’, includes the last SN of the PDU sequentially received in the RLC PDU buffer of the RLC RESET receiver 405, as shown by reference numeral 767.

Upon receiving the RLC RESET ACK message in step 770, the RLC/MAC layer 430 of the RLC RESET sender 410 reassembles an RLC SDU using the PDUs in the RLC PDU buffer of the corresponding RLC entity's receiving side depending on the sequence number included in the RLC RESET ACK message, and transmits the reassembled SDU to the RLC SDU buffer, in step 775.

Thereafter, in step 780, the RLC/MAC layer 430 of the RLC RESET sender 410 clears the RLC PDU buffer, and initializes the necessary control information, parameter, and timer, completing the RLC RESET control process.

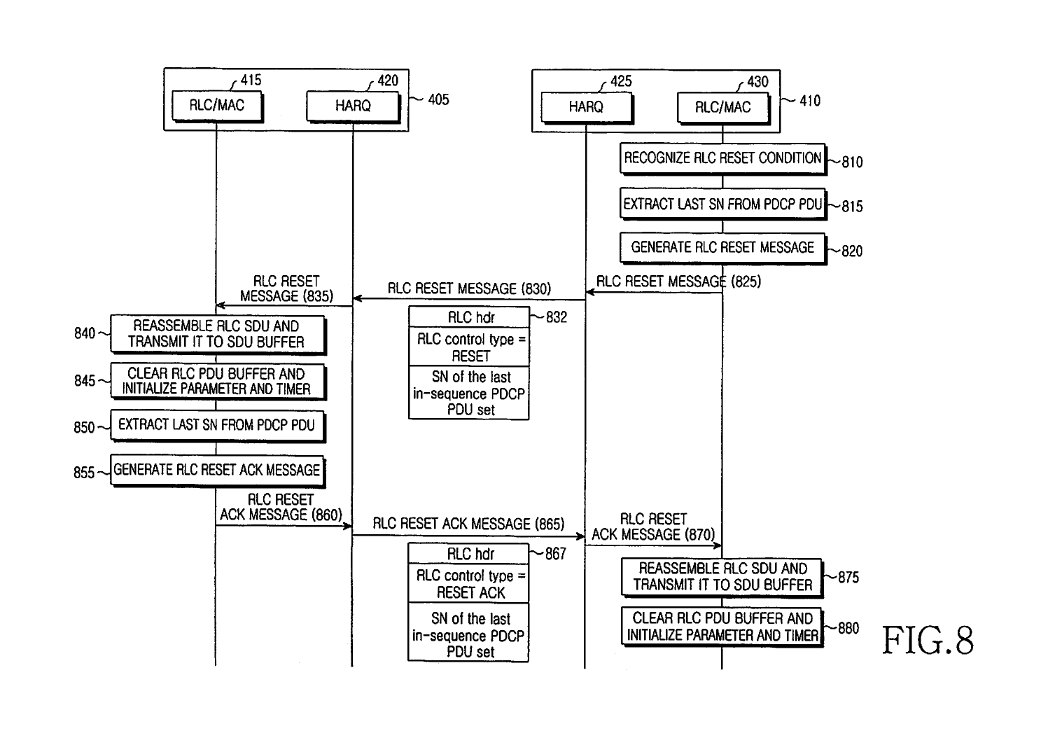

FIG. 8 illustrates a data transmission/reception method in a mobile communication system according to a second embodiment of the present invention. FIG. 8 illustrates the entire operation of the RLC RESET sender and the RLC RESET receiver for the RLC RESET process that uses the last sequence number of the successfully received RLC PDU.

Upon recognizing an RLC RESET condition in step 810, the RLC/MAC layer 430 of the RLC RESET sender 410 extracts the last sequence number of the continuously sequentially received PDU from the PDCP PDU buffer of its receiving side, in step 815. In this case, the RLC layer can receive the sequence number transmitted from the PDCP layer by transmitting a request for the sequence number to the PDCP layer, or the RLC layer can store the last sequence number when transmitting the PDCP PDU to the PDCP layer, to use the last sequence number later. In the former case, the RLC layer needs an interface with the PDCP layer, and in the latter case, the RLC layer can process the sequence number without an interface with the PDCP layer.

Thereafter, in step 820, the RLC/MAC layer 430 of the RLC RESET sender 410 generates an RLC RESET message including the sequence number extracted from the PDCP and completes transmission preparation for the generated RLC RESET message.

In steps 825 and 830, the RLC/MAC layer 430 of the RLC RESET sender 410 transmits the transmission-prepared RLC RESET message to the RLC RESET receiver 405 via the HARQ 425. Herein, the RLC RESET message includes a status of a receiving-side buffer of the RLC RESET sender 410.

The status of the receiving-side buffer, in which ‘RESET’ indicates the RLC control type, includes the last SN of the PDU sequentially received in the PDCP PDU buffer of the RLC RESET sender 410, as shown by reference numeral 832. When the counterpart HARQ 420 transmits an HARQ ACK in response to the HARQ packet transmitted by the HARQ 425, the HARQ packet transmission is completed.

After transmitting the RLC RESET message, the RLC RESET sender 410 stops the HARQ packet transmission by the corresponding RLC entity and resets the HARQ PDU.

Upon receiving the RLC RESET message in step 835, the RLC/MAC layer 415 of the RLC RESET receiver 405 reassembles an RLC SDU using the PDUs in the RLC PDU buffer of the corresponding RLC entity's receiving side depending on the sequence number included in the RLC RESET message, and transmits the reassembled SDU to the RLC SDU buffer, in step 840. In the foregoing operation of the present invention, the transmitting side of the RLC entity receives information on the normally received packet from the relevant RLC entity's receiving side, and transmits the packets from its succeeding packet depending on the received information, thus enabling lossless data transmission.

Thereafter, in step 845, the RLC/MAC layer 415 of the RLC RESET receiver 405 clears the RLC PDU buffer, and initializes the necessary control information, parameter, and timer.

After the RESET process, in step 850, the RLC/MAC layer 415 of the RLC RESET receiver 405, like the RLC RESET sender 410, extracts the last sequence number of the continuously sequentially received PDU from the RLC PDU buffer of its receiving side. Thereafter, in step 855, the RLC/MAC layer 415 of the RLC RESET receiver 405 generates an RLC RESET ACK message including the extracted sequence number, and completes transmission preparation for the generated RLC RESET ACK message.

In steps 860 and 865, the RLC/MAC layer 415 of the RLC RESET receiver 405 transmits the transmission-prepared RLC RESET ACK message to the RLC RESET sender 410 via the HARQ 420. Herein, the RLC RESET ACK message includes a status of the receiving-side buffer of the RLC RESET receiver 405.

The status of the receiving-side buffer, in which ‘RESET ACK’ indicates the RLC control type, includes the last SN of the PDU sequentially received in the PDCP PDU buffer of the RLC RESET receiver 405, as shown by reference numeral 867.

Upon receiving the RLC RESET ACK message in step 870, the RLC/MAC layer 430 of the RLC RESET sender 410 reassembles an RLC SDU using the PDUs in the RLC PDU buffer of the corresponding RLC entity's receiving side depending on the sequence number included in the RLC RESET ACK message, and transmits the reassembled SDU to the RLC SDU buffer, in step 875.

Thereafter, in step 880, the RLC/MAC layer 430 of the RLC RESET sender 410 clears the RLC PDU buffer, and initializes the necessary control information, parameter and timer, completing the RLC RESET control process.

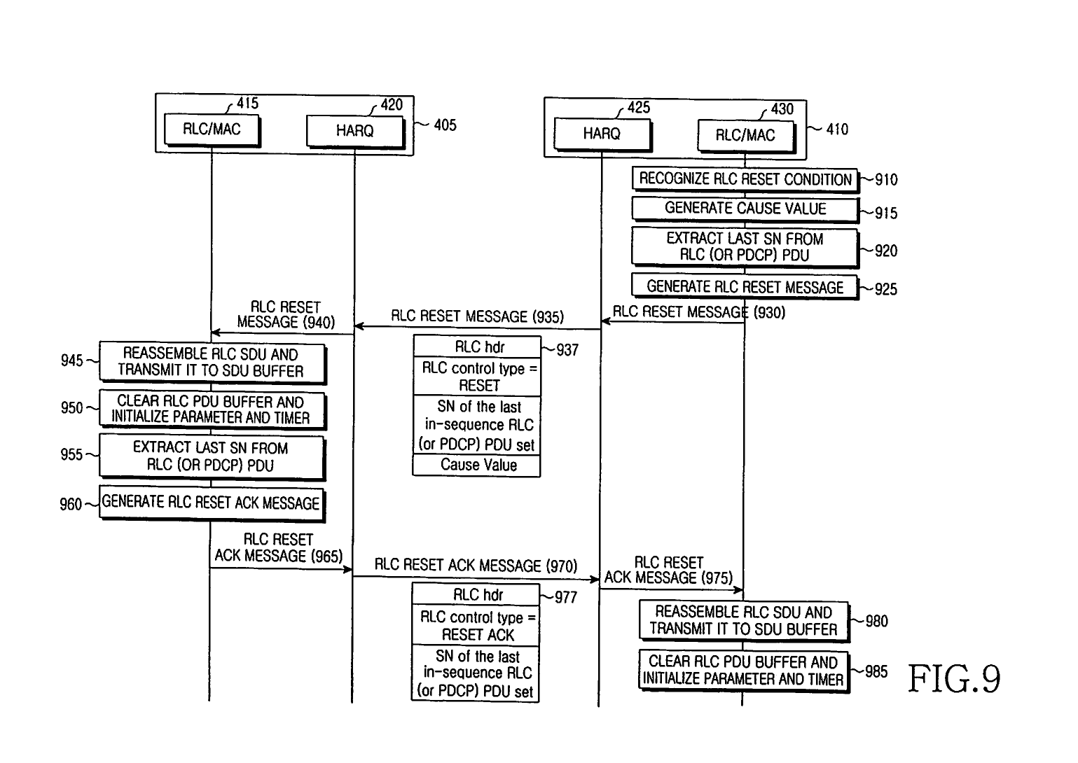

FIG. 9 illustrates a data transmission/reception method in a mobile communication system according to a third embodiment of the present invention. In particular, FIG. 9 illustrates a method for efficiently transmitting data using the cause value based on the RLC RESET occurrence condition and the last sequence number of the successfully received RLC (or PDCP) PDU.

As described above, when the transmission of a particular packet is continuously failed for unknown reasons, or when inconsistency is discovered in the RLC PDU sequence number, the RLC reset can occur. For the former case where the packet transmission is continuously failed, it is possible to apply the first embodiment of the present invention because the transmission failure is not caused by the reliability of the sequence number of the RLC PDU. However, for the latter case where the inconsistency is discovered in the RLC PDU sequence number, because the RLC PDU sequence number is unreliable, it is preferable to apply the second embodiment that uses the sequence number of the high-reliability PDCP PDU, rather than using the first embodiment of the present invention.

The first embodiment, as it uses the RLC PDU sequence number, does not need an interface with the PDCP layer, so the first embodiment can be lower than the second embodiment in terms of the implementation complexity and the processing.

Based on this, the third embodiment of the present invention provides a method for efficiently transmitting data according to the RLC RESET conditions defined in Table 1.

FIG. 9 illustrates the entire operation of a RLC RESET sender and a RLC RESET receiver for the RLC RESET process that selectively uses the sequence number of the successfully received RLC (or PDCP) PDU depending on the cause value based on the RLC RESET occurrence condition, according to the third embodiment of the present invention.

Upon recognizing an RLC RESET condition in step 910, the RLC/MAC layer 430 of the RLC RESET sender 410 generates a cause value corresponding to the condition defined in Table 1, in step 915. In step 920, the RLC/MAC layer 430 of the RLC RESET sender 410 extracts the last sequence number of the continuously sequentially received RLC (or PDCP) PDU from the PDU buffer corresponding to the cause value in its receiving side. Referring to Table 1, when the cause value is ‘00’, the RLC/MAC layer 430 extracts the RLC PDU sequence number, and when the cause value is ‘01’ or ‘10’, the RLC/MAC layer 430 extracts the PDCP PDU sequence number. Thereafter, in step 925, the RLC/MAC layer 430 of the RLC RESET sender 410 generates an RLC RESET message including the extracted sequence number and the cause value, and completes transmission preparation for the generated RLC RESET message.

TABLE 1

| Cause | | | |
|---|---|---|---|
| Value | Condition | Application | Remarks |
| 00 | RLC PDU retransmissions | RLC SN | This case can occur due to |
| | are performed as many | applied. | radio environment, and first |
| | times as the maximum | | embodiment having higher |
| | number defined by upper layer. | | processing speed than first |
| | | | embodiment is applied. |
| 01 | Window of receiving buffer | PDCP SN | Reliability of RLC SN |
| | shifts over the maximum | applied | decreases due to an |
| | value of operation range. | | abnormal cause. Second |
| | | | embodiment using high- |
| | | | reliability PDCP SN is applied. |
| 10 | There is error in the | PDCP SN | Reliability of RLC SN |
| | sequence number of the | applied | decreases due to an |
| | STATUS PDU | | abnormal cause. Second |
| | | | embodiment using high- |
| | | | reliability PDCP SN is |
| | | | applied. |
| 11 | Reserved (applicable to | Reserved | Reserved |
| | other causes) | | |

In steps 930 and 935, the RLC/MAC layer 430 of the RLC RESET sender 410 transmits the transmission-prepared RLC RESET message to the RLC RESET receiver 405 via HARQ 425. Herein, the RLC RESET message includes a status of the receiving-side buffer of the RLC RESET sender 410.

The status of the receiving-side buffer, in which RLC control type is indicated as ‘RESET’, includes the last SN of the PDU sequentially received in the RLC (or PDCP) PDU buffer of the RLC RESET sender 410, as shown by reference numeral 937. The status includes even the cause value corresponding to the RESET condition. The HARQ packet transmission is completed when the counterpart HARQ 420 transmits an HARQ ACK in response to the HARQ packet transmitted by the HARQ 425.

After transmitting the RLC RESET message, the RLC RESET sender 410 stops the HARQ packet transmission by the corresponding RLC entity, and resets the HARQ PDU. In this case, if the RLC layer recognizes the RESET condition, the upper layer resets the HARQ PDU.

Upon receiving the RLC RESET message in step 940, the RLC/MAC layer 415 of the RLC RESET receiver 405 stops the corresponding HARQ packet transmission, and resets the HARQ PDU. In step 945, the RLC/MAC layer 415 of the RLC RESET receiver 405 reassembles an RLC SDU using the PDUs in the RLC PDU buffer of the corresponding RLC entity's receiving side depending on the sequence number and the cause value included in the RLC RESET message, and transmits the reassembled SDU to the RLC SDU buffer. In the foregoing operation of the present invention, the transmitting side of the RLC entity receives information on the normally received packet from the relevant RLC entity's receiving side, and transmits the packets from its succeeding packet depending on the received information, thus enabling lossless data transmission.

Thereafter, in step 950, the RLC/MAC layer 415 of the RLC RESET receiver 405 clears the RLC PDU buffer, and initializes the necessary control information, parameter and timer.

After the RESET process, the RLC/MAC layer 415 of the RLC RESET receiver 405, like the RLC RESET sender 410, extracts the last sequence number of the continuously sequentially received PDU from the RLC (or PDCP) PDU buffer corresponding to the cause value in its receiving side, in step 955. Thereafter, in step 960, the RLC/MAC layer 415 of the RLC RESET receiver 405 generates an RLC RESET ACK message including the extracted sequence number and cause value, and completes transmission preparation for the generated RLC RESET ACK message.

In steps 965 and 970, the RLC/MAC layer 415 of the RLC RESET receiver 405 transmits the transmission-prepared RLC RESET ACK message to the RLC RESET sender 410 via the HARQ 420. Herein, the RLC RESET ACK message includes a status of the receiving-side buffer of the RLC RESET receiver 405.

The status of the receiving-side buffer, in which ‘RESET ACK’ indicates the RLC control type, includes the last SN of the PDU sequentially received in the RLC PDU buffer of the RLC RESET receiver 405, as shown by reference numeral 977.

Upon receiving the RLC RESET ACK message in step 975, the RLC/MAC layer 430 of the RLC RESET sender 410 reassembles an RLC SDU using the PDUs in the RLC (or PDCP) PDU buffer of the corresponding RLC entity's receiving side depending on the sequence number included in the RLC RESET ACK message, and transmits the reassembled SDU to the RLC SDU buffer, in step 980.

Thereafter, in step 985, the RLC/MAC layer 430 of the RLC RESET sender 410 clears the RLC PDU buffer, and initializes the necessary control information, parameter and timer, completing the RLC RESET control process.

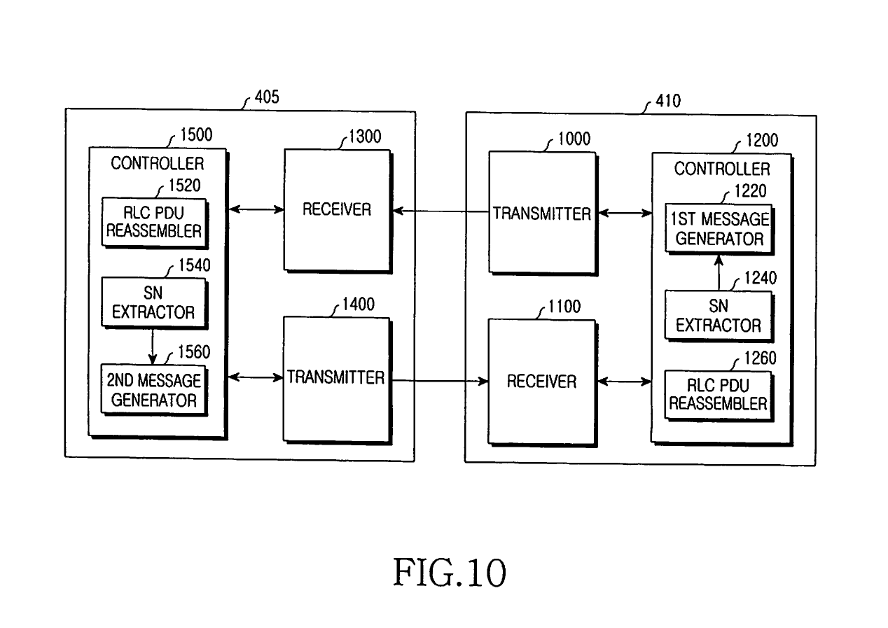

FIG. 10 illustrates a structure of a data transmission/reception apparatus in a mobile communication system according to an embodiment of the present invention.

In the mobile communication system, the data transmission/reception apparatus includes a RLC RESET sender 410 and a RLC RESET receiver 405. As described above, the RLC entities of the RLC layers exist in pairs, and each entity is composed of a transmitting side for transmitting an arbitrary packet in the entity itself, and a receiving side for receiving a packet.

The RLC RESET sender 410 includes a transmitter 1000, a receiver 1100, and a controller 1200. The controller 1200 includes a first message generator 1220, an RLC PDU reassembler 1260, and an SN extractor 1240.

The first message generator 1220, upon recognizing an RLC RESET condition, generates an RLC RESET message and outputs the RLC RESET message to the transmitter 1000. The transmitter 1000 transmits the generated RLC RESET message to the RLC RESET receiver 405. Upon receiving an RLC RESET ACK message from the RLC RESET receiver 405, the receiver 1100 forwards the RLC RESET ACK message to the controller 1200. The RLC PDU reassembler 1260 of the controller 1200 reassembles an RLC SDU using the PDUs in the RLC PDU buffer of the RLC entity's receiving side depending on a sequence number included in the RLC RESET ACK message. Thereafter, the controller 1200 performs a control operation of transmitting the reassembled SDU to the RLC SDU buffer. The controller 1200 controls both the transmitter 1000 and the receiver 1100 of the RLC RESET sender 410 to perform data transmission/reception according to an embodiment of the present invention.

Similarly, the RLC RESET receiver 405 includes a receiver 1300, a transmitter 1400, and a controller 1500. The controller 1500 includes a second message generator 1560, an RLC PDU reassembler 1520, and an SN extractor 1540.

Upon receiving an RLC RESET message from the transmitter 1000 of the RLC RESET sender 410, the receiver 1300 provides the controller 1500 with information on the receipt of the RLC RESET message. Then the controller 1500 performs an operation of stopping the HARQ packet transmission and resetting the HARQ PDU, and the SN extractor 1540 in the controller 1500 extracts the last sequence number of the continuously sequentially received PDU from its receiving-side RLC PDU buffer. The second message generator 1560 generates an RLC RESET ACK message including the extracted sequence number, and outputs the RLC RESET ACK message to the transmitter 1400. The transmitter 1400 transmits the RLC RESET ACK message to the RLC RESET sender 410. The controller 1500 controls both the receiver 1300 and the transmitter 1400 to perform data transmission/reception according to an embodiment of the present invention.

As is apparent from the foregoing description, in the RLC RESET operation of the mobile communication system, the present invention provides information on the normally received packet of each RLC entity's receiving side to the counterpart RLC entity's transmitting side to enable lossless data transmission for its succeeding packets, thereby preventing a loss of the transmission data, which may occur during the RLC RESET operation, and thus contributing to an increase in the transmission efficiency.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting/receiving data by a Radio Link Control (RLC) RESET sender in a mobile communication system, the method comprising:
upon an occurrence of a Radio Link Control (RLC) RESET, generating an RLC RESET message and transmitting the RLC RESET message to a RLC RESET receiver; and
upon receiving an RLC RESET ACKnowledgement (ACK) message from the RLC RESET receiver, reassembling an RLC Service Data Unit (SDU) using Packet Data Units (PDUs) in an RLC PDU buffer depending on a sequence number included in the RLC RESET ACK message, and transmitting the reassembled RLC SDU to an RLC SDU buffer,
wherein the sequence number includes a last sequence number of a PDU continuously sequentially received in an RLC PDU buffer of the RLC RESET receiver.

2. The method of claim 1, wherein the sequence number further includes a last sequence number of a PDU continuously sequentially received in a Packet Data Convergence Protocol (PDCP) PDU buffer of the RLC RESET receiver.

3. The method of claim 1, wherein the sequence number further includes a last sequence number of a PDCP PDU or an RLC PDU continuously sequentially received in a PDCP PDU or an RLC PDU buffer of the RLC RESET receiver according to a cause value.

4. The method of claim 1, wherein the RLC RESET message includes receiving-side buffer status information of the RLC RESET sender.

5. The method of claim 1, wherein the RLC RESET ACK message includes receiving-side buffer status information of the RLC RESET receiver.

6. A method for transmitting/receiving data by a Radio Link Control (RLC) RESET receiver in a mobile communication system, the method comprising:
upon receiving an Radio Link Control (RLC) RESET message from a RLC RESET sender, extracting a last sequence number of a Packet Data Unit (PDU) continuously sequentially received in a receiving-side RLC PDU buffer of the RLC RESET receiver; and
generating an RLC RESET Acknowledgement (ACK) message including the extracted sequence number, and transmitting the RLC RESET ACK message to the RLC RESET sender.

7. The method of claim 6, wherein the sequence number further includes a last sequence number of a PDU continuously sequentially received in a Packet Data Convergence Protocol (PDCP) PDU buffer of the RLC RESET receiver.

8. The method of claim 6, wherein the sequence number further includes a last sequence number of a PDCP PDU or an RLC PDU continuously sequentially received in a PDCP PDU or an RLC PDU buffer of the RLC RESET receiver according to a cause value.

9. The method of claim 6, wherein the RLC RESET message includes receiving-side buffer status information of the RLC RESET sender.

10. The method of claim 6, wherein the RLC RESET ACK message includes receiving-side buffer status information of the RLC RESET receiver.

11. A method for transmitting/receiving data between a Radio Link Control (RLC) RESET sender and a RLC RESET receiver in a mobile communication system, the method comprising:
upon an occurrence of an Radio Link Control (RLC) RESET, generating, by the RLC RESET sender, an RLC RESET message and transmitting the RLC RESET message to the RLC RESET receiver;
upon receiving the RLC RESET message from the RLC RESET sender, extracting by the RLC RESET receiver a last sequence number of a Packet Data Unit (PDU) continuously sequentially received in a receiving-side RLC PDU buffer of the RLC RESET receiver;
generating by the RLC RESET receiver an RLC RESET ACKnowledgement (ACK) message including the extracted sequence number, and transmitting the RLC RESET ACK message to the RLC RESET sender; and
upon receiving the RLC RESET ACK message from the RLC RESET receiver, reassembling, by the RLC RESET sender, an RLC Service Data Unit (SDU) using PDUs in an RLC PDU buffer depending on a sequence number included in the RLC RESET ACK message, and transmitting the reassembled RLC SDU to an RLC SDU buffer.

12. The method of claim 11, wherein the sequence number further includes a last sequence number of a PDU continuously sequentially received in a Packet Data Convergence Protocol (PDCP) PDU buffer of the RLC RESET receiver.

13. The method of claim 11, wherein the sequence number further includes a last sequence number of a PDCP PDU or an RLC PDU continuously sequentially received in a PDCP PDU or an RLC PDU buffer of the RLC RESET receiver according to a cause value.

14. The method of claim 11, wherein the RLC RESET message includes receiving-side buffer status information of the RLC RESET sender.

15. The method of claim 11, wherein the RLC RESET ACK message includes receiving-side buffer status information of the RLC RESET receiver.

16. An apparatus for transmitting/receiving data in a Radio Link Control (RLC) RESET sender of a mobile communication system, the apparatus comprising:
a first message generator for generating an Radio Link Control (RLC) RESET message upon an occurrence of an RLC RESET;
a transmitter for transmitting the generated RLC RESET message to a RLC RESET receiver;
a receiver for transmitting, to a controller, an RLC RESET ACKnowledgement (ACK) message received from the RLC RESET receiver;
an RLC Packet Data Unit (PDU) reassembler for reassembling an RLC Service Data Unit (SDU) using PDUs in an RLC PDU buffer of the RLC RESET receiver depending on a sequence number included in the RLC RESET ACK message; and
the controller for performing a control operation of transmitting the reassembled SDU to the RLC SDU buffer,
wherein the sequence number includes a last sequence number of a PDU continuously sequentially received in an RLC PDU buffer of the RLC RESET receiver.

17. The apparatus of claim 16, wherein the sequence number further includes a last sequence number of a PDU continuously sequentially received in a Packet Data Convergence Protocol (PDCP) PDU buffer of the RLC RESET receiver.

18. The apparatus of claim 16, wherein the sequence number further includes a last sequence number of a PDCP PDU or an RLC PDU continuously sequentially received in a PDCP PDU or RLC PDU buffer of the RLC RESET receiver according to a cause value.

19. The apparatus of claim 16, wherein the RLC RESET message includes receiving-side buffer status information of the RLC RESET sender.

20. The apparatus of claim 16, wherein the RLC RESET ACK message includes receiving-side buffer status information of the RLC RESET receiver.

21. An apparatus for transmitting/receiving data in a Radio Link Control (RLC) RESET receiver of a mobile communication system, the apparatus comprising:
a receiver for receiving an Radio Link Control (RLC) RESET message from a RLC RESET sender;
a sequence number extractor for extracting a last sequence number of a Packet Data Unit (PDU) continuously sequentially received in a receiving-side RLC PDU buffer of the RLC RESET receiver;
a second message generator for generating an RLC RESET Acknowledgement (ACK) message including the extracted sequence number; and
a transmitter for transmitting the generated RLC RESET ACK message to the RLC RESET sender.

22. The apparatus of claim 21, wherein the sequence number further includes a last sequence number of a PDU continuously sequentially received in a Packet Data Convergence Protocol (PDCP) PDU buffer of the RLC RESET receiver.

23. The apparatus of claim 21, wherein the sequence number further includes a last sequence number of a PDCP PDU or an RLC PDU continuously sequentially received in a PDCP PDU or an RLC PDU buffer of the RLC RESET receiver according to a cause value.

24. The apparatus of claim 21, wherein the RLC RESET message includes receiving-side buffer status information of the RLC RESET sender.

25. The apparatus of claim 21, wherein the RLC RESET ACK message includes receiving-side buffer status information of the RLC RESET receiver.
